(19) United States
(12) Patent Application Publication
(10) Pub. No.: US 2017/0223613 A1
(43) Pub. Date: Aug. 3, 2017

(54) CONNECTING ONE ELECTRONIC DEVICE TO INTERNET THROUGH ANOTHER ELECTRONIC DEVICE

(71) Applicant: Harman International Industries, Incorporated, STamford, CT (US)

(72) Inventors: Junhao Wang, Shanghai (CN); Qingshan Zhang, Shanghai (CN); Zeng Yang, Shanghai (CN)

(73) Assignee: Harman International Industries, Incorporated, Stamford, CT (US)

(21) Appl. No.: 15/301,073

(22) PCT Filed: Apr. 28, 2014
(86) PCT No.: PCT/CN14/76354

§ 371 Date: Sep. 30, 2016

(51) Int. Cl. H04W 48/14; H04W 12/08; H04W 12/06; H04L 29/06; H04B 11/00; H04L 12/28

(52) U.S. Cl. CPC H04W 48/14; H04B 11/00; H04L 12/2856; H04W 12/06; H04L 63/083; H04W 12/08; H04L 63/10; H04W 88/04

(57) ABSTRACT

Method for connecting a first electronic device to internet through another electronic device and first electronic devices are provided. The method includes: the first electronic device broadcasting an acoustic signal which carries configuration information for configuring access point, where the configuration information includes an access point identifier, where the configuration information can be extracted from the acoustic signal by another electronic device that receives the acoustic signal and can be used to configure the electronic device as an access point; when an access point having the identifier is detected by the first electronic device, sending to the access point a request for connecting to it to access internet service; and connecting to internet through the access point after a notice of permission is received from the access point. The first electronic device connects to internet through another electronic device conveniently without configuring an access point and inputting a password manually.

### TECHNICAL FIELD

The present disclosure generally relates to connecting one electronic device to internet through another electronic device.

### BACKGROUND

Nowadays, many mobile devices, such as smart phones etc., can be configured as an access point, and other devices can connect to internet through such access point. Usually, to connect a first electronic device to internet through a second electronic device, the second electronic device shall be configured as an access point and a password for accessing the second electronic device shall be set, then the user shall manually select the second electronic device and input the password on the first electronic device. The whole process is very inconvenient. Therefore, there is need for more convenient method.

### SUMMARY

In one embodiment, a method for connecting a first electronic device to internet through another electronic device is provided. The method may include: the first electronic device broadcasting an acoustic signal which carries configuration information for configuring access point, where the configuration information includes an access point identifier, where the configuration information can be extracted from the acoustic signal by another electronic device that receives the acoustic signal and can be used to configure the electronic device as an access point; when an access point having the identifier is detected by the first electronic device, the first electronic device sending to the access point a request for connecting to it to access internet service; and the first electronic device connecting to internet through the access point after a notice of permission is received from the access point.

In some embodiments, the connection between the first electronic device and the access point may be Wi-Fi connection. The configuration information may further include a password. The access point may be configured based on the access point identifier and the password, and the first electronic device may connect to the access point using the password which is contained in the request for connecting to the access point.

In some embodiments, the connection between the first electronic device and the access point may be Bluetooth connection. The configuration information may further include an identifier of the first electronic device. The access point may be configured based on the access point identifier, and the first electronic device may connect to the access point using the identifier of the first electronic device which is contained in the request for connecting to the access point.

In some embodiments, the method may further include: the first electronic device obtaining the configuration information for configuring access point; encoding the configuration information; and modulating the encoded configuration information to form the acoustic signal. In some embodiments, the configuration information may be pre-stored in the first electronic device. In some embodiments, the configuration information may be input by a user.

In some embodiments, the acoustic signal may be substantially inaudible, for example, its frequency may be above 16 KHz. In some embodiments, the frequency of the acoustic signal may be above 17 KHz. In some embodiments, the frequency of the acoustic signal may be above 19 KHz. In some embodiments, the frequency of the acoustic signal may be above 19 KHz and below 23 KHz.

In some embodiments, the acoustic signal may be broadcasted all the time. In some embodiments, when the access point having the identifier is detected, the first electronic device may stop broadcasting the acoustic signal. In some embodiments, the acoustic signal may be broadcasted under control of a user.

In one embodiment, a method for connecting a first electronic device to internet through a second electronic device is provided. The method may include: the second electronic device receiving an acoustic signal which carries configuration information for configuring access point; the second electronic device extracting the configuration information from the received acoustic signal; the second electronic device configuring itself as an access point using the extracted configuration information; after configured to access point, the second electronic device receiving a request for connecting to it to access internet service from the first electronic device; and the second electronic device sending a notice of permission to the first electronic device.

In some embodiments, the connection between the first and second electronic devices may be Wi-Fi connection, and the configuration information may include an access point identifier and a password. Such that, the second electronic device may configure itself as the access point using the access point identifier and the password. After receiving the request from the first electronic device for connecting to the access point which request contains the password, the second electronic device may send the notice of permission to the first electronic device so that the first electronic device can connect to internet through the access point.

In some embodiments, the connection between the first and second electronic devices may be Bluetooth connection, and the configuration information may include an identifier of the first electronic device and an access point identifier. Such that, the second electronic device may configure itself as the access point using the access point identifier. After receiving the request from the first electronic device for connecting to the access point which request contains the identifier of the first electronic device, the second electronic device may send the notice of permission to the first electronic device so that the first electronic device can connect to internet through the access point.

In some embodiments, the acoustic signal may be substantially inaudible, for example, its frequency may be above 16 KHz. In some embodiments, the frequency of the acoustic signal may be above 17 KHz. In some embodiments, the frequency of the acoustic signal may be above 19 KHz. In some embodiments, the frequency of the acoustic signal may be above 19 KHz and below 23 KHz.

In some embodiments, extracting the configuration information from the received acoustic signal may include: demodulating the received acoustic signal; and decoding the demodulated acoustic signal to obtain the configuration information.

In one embodiment, a first electronic device is provided. The first electronic device may include a speaker system, a wireless communication device and a processing device configured to: control the speaker system to broadcast an acoustic signal which carries configuration information for configuring access point, where the configuration information includes an access point identifier, where the configuration information can be extracted from the acoustic signal by another electronic device that receives the acoustic signal and can be used to configure the electronic device as an access point; control the first electronic device to search an access point having the identifier; after the access point having the identifier is detected, generate a request for connecting to the access point; control the wireless communication device to send the request to the access point to access internet service; and control the wireless communication device to connect to internet through the access point after a notice of permission is received from the access point by the wireless communication device.

In some embodiments, the acoustic signal may be substantially inaudible, for example, its frequency may be above 16 KHz. In some embodiments, the frequency of the acoustic signal may be above 17 KHz. In some embodiments, the frequency of the acoustic signal may be above 19 KHz. In some embodiments, the frequency of the acoustic signal may be above 19 KHz and below 23 KHz.

In some embodiments, the processing device may be further configured to: obtain the configuration information for configuring access point; encode the configuration information; and modulate the encoded configuration information to form the acoustic signal.

In some embodiments, the connection between the first electronic device and the access point may be Wi-Fi connection. The configuration information may further include a password. The access point may be configured based on the access point identifier and the password, and the processing device in the first electronic device may control the wireless communication device to connect to the access point using the password which is contained in the request for connecting to the access point.

In some embodiments, the connection between the first electronic device and the access point may be Bluetooth connection. The configuration information may further include an identifier of the first electronic device. The access point may be configured based on the access point identifier, and the processing device in the first electronic device may control the wireless communication device to connect to the access point using the identifier of the first electronic device which is contained in the request for connecting to the access point.

In some embodiments, the processing device may be configured to control the speaker system to broadcast the acoustic signal all the time. In some embodiments, when the access point having the identifier is detected, the processing device may be further configured to: control the speaker system to stop broadcasting the acoustic signal. In some embodiments, the speaker system may be configured to broadcast the acoustic signal under control of a user.

In one embodiment, a first electronic device is provided. The first electronic device may include an acoustic signal receiving device, a wireless communication device and a processing device configured to: after the acoustic signal receiving device receives an acoustic signal which carries configuration information for configuring access point, extract the configuration information from the received acoustic signal; configure the first electronic device as an access point based on the configuration information; and after a request for connecting to the access point is received from a second electronic device by the wireless communication device, control the wireless communication device to send a notice of permission to the second electronic device.

In some embodiments, the connection between the first and second electronic devices may be Wi-Fi connection, and the configuration information may include an access point identifier and a password. Such that, the processing device may configure the first electronic device as the access point using the access point identifier and the password. After the request for connecting to the access point which request contains the password is received from the second electronic device by the wireless communication device, the processing device may control the wireless communication device to send the notice of permission to the second electronic device so that the second electronic device can connect to internet through the access point.

In some embodiments, the connection between the first and second electronic devices may be Bluetooth connection, and the configuration information may include an identifier of the second electronic device and an access point identifier. Such that, the processing device may configure the first electronic device as the access point using the access point identifier. After the request for connecting to the access point which request contains the identifier of the second electronic device is received from the second electronic device by the wireless communication device, the processing device may control the wireless communication device to send the notice of permission to the second electronic device so that the second electronic device can connect to internet through the access point.

In some embodiments, the acoustic signal may be substantially inaudible, for example, its frequency may be above 16 KHz. In some embodiments, the frequency of the acoustic signal may be above 17 KHz. In some embodiments, the frequency of the acoustic signal may be above 19 KHz. In some embodiments, the frequency of the acoustic signal may be above 19 KHz and below 23 KHz.

In some embodiments, the processing device may be further configured to: demodulate the received acoustic signal; and decode the demodulated acoustic signal to obtain the configuration information.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a flow chart of a method 100 for connecting a first electronic device to internet through a second electronic device according to one embodiment;

FIG. 2 is a schematic diagram of a wireless network environment;

FIG. 3 is a schematic block diagram of a first electronic device 300 according to one embodiment; and

FIG. 4 is a schematic block diagram of a second electronic device 400 according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

To connect a first electronic device to internet through another electronic device, the another electronic device needs to configure itself as an Access Point (AP) and the first electronic device needs to search the AP and request to connect with the AP.

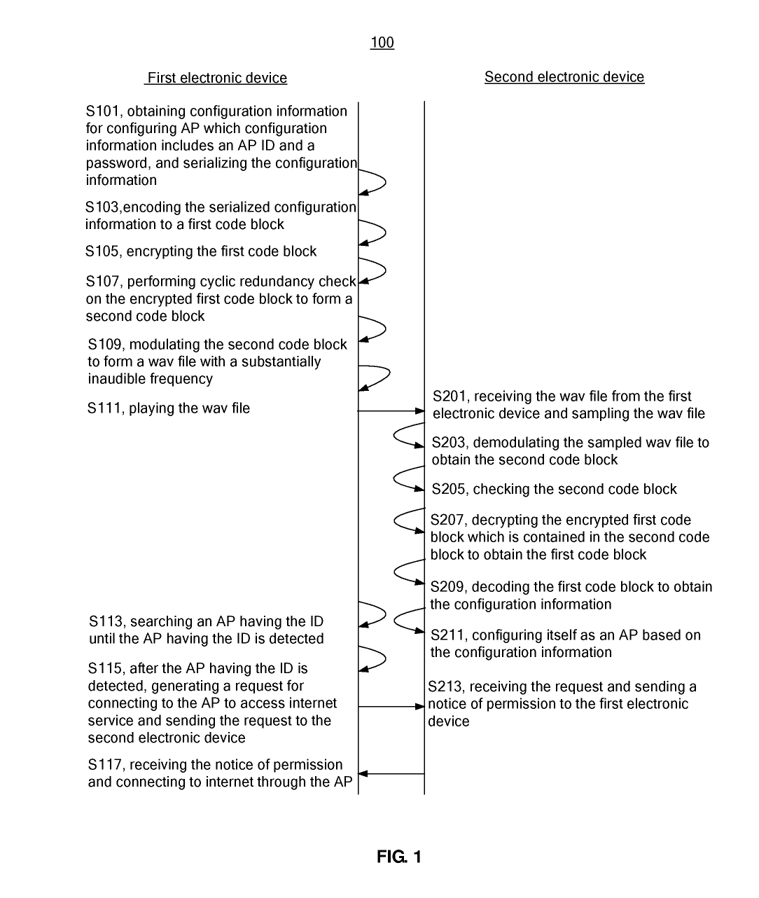

FIG. 1 is a flow chart of a method 100 for connecting a first electronic device to internet through a second electronic device according to one embodiment. In the embodiment, connection between the first and second electronic devices is Wi-Fi connection. In other embodiments, the connection between the first and second electronic devices may be Bluetooth (BT) connection.

Referring to FIG. 1, in S101, a first electronic device obtaining configuration information for configuring AP which configuration information includes an AP identifier (ID) and a password, and serializing the configuration information.

The first electronic device may be a vehicle-mounted device, such as a head unit, or mobile devices. In some embodiments, serializing the configuration information may include concatenating the configuration information into a string.

In S103, the first electronic device encoding the serialized configuration information to a first code block.

In some embodiments, the serialized configuration information may be encoded according to American Standard Code for Information Interchange (ASCII) table to form a first code block.

In S105, the first electronic device encrypting the first code block.

In some embodiments, the first code block may be encrypted by a reversible encryption algorithm, such as symmetric-key algorithm including Data Encryption Algorithm (DEA) algorithm, Triple Data Encryption Algorithm (TDEA) algorithm and RC5 algorithm. Besides, a keyt may be used in the encryption process. In some embodiments, S105 may not be performed.

In S107, the first electronic device performing Cyclic Redundancy Check (CRC) on the encrypted first code block to form a second code block.

In some embodiments, an error correcting code, which is calculated based on the encrypted first code block in a certain mathematical relation, may be added to the end of the encrypted first code block to form the second code block.

In S109, the first electronic device modulating the second code block to form a way file with a substantially inaudible frequency.

In some embodiments, the second code block may be encoded by a certain encoding method, such as a repeated encoding method, to form an encoded block. Then, a first modulation process, such as a Phase-Shift-Keying (PSK) modulation method, may be applied to the encoded block to form a set of symbols. A second modulation process, such as Time Division Multiplexing (TDM), Frequency Division Multiplexing (FDM) and Code Division Multiplexing (CDM), may be applied to the set of symbols to form a base band signal. Afterward, a carrier wave may be used to carry the base band signal to form a wave signal. In some embodiments, the carrier wave may have a substantially inaudible frequency, for example, above 16 KHz. In some embodiments, the frequency of the acoustic signal may be above 17 KHz or 19 KHz. In some embodiments, the frequency of the acoustic signal may be above 19 KHz and below 23 KHz. Finally, a way file with the substantially inaudible frequency, which can be played by a speaker, may be constructed based on the wave signal.

In S111, the first electronic device playing the way file.

To play the way file, the first electronic device may have a speaker. In some embodiments, the way file may be played all the time. In some embodiments, the way file may be played under control. For example, if it is in a vehicle, the first electronic device may be triggered to play the way file when it wants to connect to internet through another electronic device which can configure itself as an AP based on the configuration information.

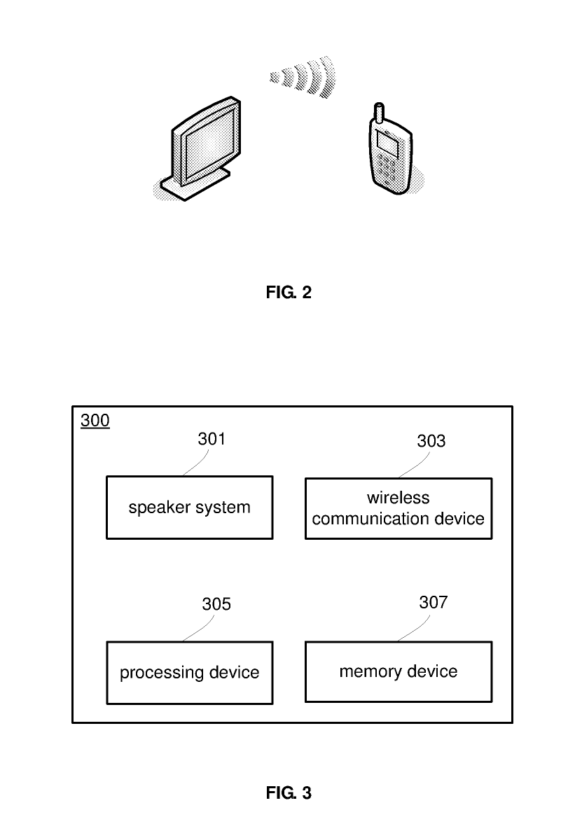

FIG. 2 is a schematic diagram of a wireless network environment. As shown in FIG. 2, the first electronic device broadcasts an acoustic signal which has a substantially inaudible frequency, and the second electronic device with a microphone around may receive the acoustic signal.

In S201, the second electronic device receiving the way file from the first electronic device and sampling the way file.

In some embodiments, the second electronic device may be a mobile device which can configure itself as an AP based on the configuration information contained in the received way file, such as a mobile phone. The second electronic device may have a microphone to receive the way file.

In some embodiments, the way file may be recorded and sampled by an Analog-to-Digital (A/D) converter with a sampling frequency of 48 KHz.

In S203, the second electronic device demodulating the sampled way file to obtain the second code block.

Since noise exists during the reception of the way file, in some embodiments, the way file may be put into a high pass filter in the second electronic device so that only a high frequency portion thereof remains.

Afterwards, a first and second demodulation processes, which respectively correspond to the second and first modulation processes in S109, may be employed to demodulate the way file to obtain the encoded block. And the encoded block may be decoded by a decoding method corresponding to the certain encoding method in S109 to obtain the second code block.

In S205, the second electronic device checking the second code block.

Since the second code block contains the encrypted first code block and the error correcting code, the second electronic device may determine whether the encrypted first code block is a correct code block. Specifically, the second electronic device may check whether the error correcting code and the encrypted first code block satisfy the certain mathematical relation described in S107. If yes, the encrypted first code block is determined to be a correct code block; vice versa. If the encrypted first code block is a correct code block, S207 may be performed; else, the second electronic device may wait for receiving a way file from the first electronic device again. In some embodiments, if an acoustic signal received by the second electronic device does not contain the configuration information, the second electronic device may determine that the acoustic signal does not contain the configuration information based on the check in S205.

In S207, the second electronic device decrypting the encrypted first code block which is contained in the second code block to obtain the first code block.

In some embodiments, the second electronic device may employ the keyt which is used in the encryption process in S105 to decrypt the encrypted first code block.

In S209, the second electronic device decoding the first code block to obtain the configuration information.

In some embodiments, the first code block may be decoded according to ASCII table. After the decoding process, the second electronic device may obtain the configuration information, i.e., the AP ID and the password.

In S211, the second electronic device configuring itself as an AP based on the configuration information.

In some embodiments, the second electronic device may configure itself as a Wi-Fi AP based on the AP ID and the password.

In S113, the first electronic device searching an AP having the ID until the AP having the ID is detected.

In some embodiments, after playing the way file, the first electronic device may start to search the AP having the ID.

In some embodiments, when the AP having the ID is detected, the first electronic device may stop playing the way file.

In S115, after the AP having the ID is detected, the first electronic device generating a request for connecting to the AP to access internet service and sending the request to the second electronic device.

The process may be performed as a standard Wi-Fi pairing process. In the embodiment, a connection process with an authorization type of Wi-Fi Protected Access Pre-Shared Key (WPA_PSK) is described. The first electronic device may generate a first set of information based on the configuration information, i.e., the AP ID and the password, and send the first set of information to the second electronic device. The first set of information may include Pre-Shared Key (PSK), a first random number and a Message Authentication Code (MAC). The second electronic device may generate a second random number and send it to the first electronic device. The first electronic device generates a first Message Integrity Check (MIC) based on the second random number and the first set of information, and sends the first MIC to the second electronic device.

In S213, the second electronic device receiving the request and sending a notice of permission to the first electronic device.

In some embodiments, the second electronic device may calculate a second MIC. And after receiving the first MIC from the first electronic device, the second electronic device may determine whether the first MIC is corresponding to the second MIC. If yes, the second electronic device may send the notice of permission to the first electronic device and connect with the first electronic device; vice versa.

In S117, the first electronic device receiving the notice of permission and connecting to internet through the AP.

In some embodiments, in the scenario that a plurality of mobile phones in which network service is provided exist in a vehicle and a vehicle-mounted computer is expected to access internet, the vehicle-mounted computer may broadcast an acoustic signal which carries configuration information for configuring Wi-Fi AP, where the configuration information includes an AP ID. One of the plurality of mobile phones may receive the acoustic signal first and configure a Wi-Fi AP based on the configuration information. And after broadcasting the acoustic signal, the vehicle-mounted computer may start to search a Wi-Fi AP having the ID. Once the Wi-Fi AP having the ID is detected, the vehicle-mounted computer generates and sends a request, to the Wi-Fi AP, for connecting to it to access internet service. Afterwards, Wi-Fi connection may be established between the vehicle-mounted computer and the Wi-Fi AP and the vehicle-mounted computer connects to internet through the Wi-Fi AP.

In some embodiments, in the scenario that a plurality of mobile devices in which network service is not provided are expected to access internet through a first mobile phone in which network service is provided, same configuration information may be set in the plurality of mobile devices. Therefore, after the first mobile phone configures itself as an AP based on the configuration information carried in an acoustic signal which is broadcasted by any of the plurality of mobile devices, all of the plurality of mobile devices can connect to the AP based on the configuration information and further connect to internet through the AP.

In an embodiment, a method for connecting a first electronic device to internet through a second electronic device is provided, where connection between the first and second electronic devices is BT connection. A first electronic device serializes configuration information for configuring AP, the configuration information including an AP ID and an ID of the first electronic device. Then, the first electronic device may perform encoding, encryption and modulation on the serialized configuration information in turn to form a way file with a substantially inaudible frequency. Afterward, the first electronic device plays the way file. A second electronic device, once receiving the way file, may perform demodulation, decryption and decoding on the way file to obtain the configuration information. Afterward, the second electronic device configures itself as a BT AP based on the AP ID contained in the configuration information. The first electronic device may search a BT AP having the AP ID. After the BT AP having the AP ID is detected, the first electronic device sends to the BT AP a request for connecting to the BT AP which request contains the ID of the first electronic device to access internet service. After receiving the request from the first electronic device, the BT AP may find that the ID of the first electronic device, which is contained in the configuration information, exists in the request and determine to send a notice of permission to the first electronic device. Finally, the first electronic device may receive the notice of permission from the BT AP and further connect to internet through the BT AP.

By employing the above methods, the second electronic device may configure itself as an AP without setting AP ID and a password manually, and the first electronic device may connect to the AP without searching the AP and inputting the password manually, which is more convenient for users. Further, the configuration information for configuring AP is broadcasted by the first electronic device through an acoustic signal having a substantially inaudible frequency, which avoids influence to persons. Further, no extra hardware is required in the two electronic devices.

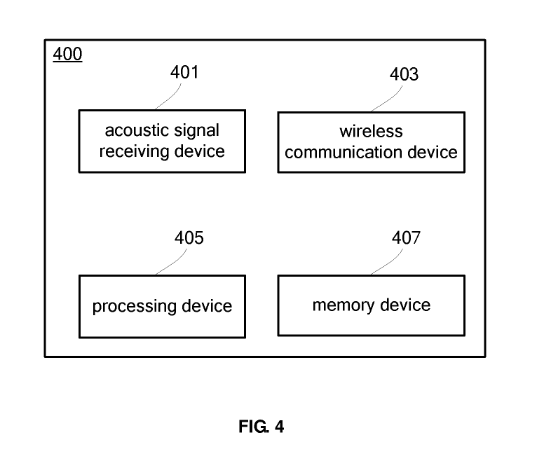

Referring to FIGS. 3 and 4, a first electronic device 300 may include a speaker system 301, a wireless communication device 303, a processing device 305 and a memory device 307. In some embodiments, the first electronic device 300 may be a vehicle-mounted computer. A second electronic device 400 may include an acoustic signal receiving device 401, a wireless communication device 403, a processing device 405 and a memory device 407. In some embodiments, the second electronic device 400 may be a mobile device, such as a mobile phone.

The processing device 305 may be configured to: obtain configuration information for configuring AP, where the configuration information includes an AP ID and a password; serialize the configuration information; encode the serialized configuration information to a first code block; encrypt the first code block; modulate the encrypted first code block to form a way file with a substantially inaudible frequency; control the speaker system 301 to play the way file, where the configuration information can be extracted from the way file by the second electronic device 400 that receives the way file and can be used to configure the second electronic device 400 as an AP; control the first electronic device 300 to search an AP having the AP ID; after the AP having the AP ID is detected, generate a request for connecting to the AP; control the wireless communication device 303 to send the request to the AP to access internet service; and control the wireless communication device 303 to connect to internet through the AP after a notice of permission is received from the AP by the wireless communication device 303.

In some embodiments, after the AP having the ID is detected, the processing device 305 may be further configured to: control the speaker system 301 to stop broadcasting the way file.

In some embodiments, the processing device 305 may be a CPU, or a MCU, or a DSP etc., or any combination thereof. The memory device 307 may store an operating system and program instructions.

In some embodiments, the acoustic signal receiving device 401 may be a microphone.

The processing device 405 may be configured to: after the acoustic signal receiving device 401 receives the way file from the first electronic device 300, sample the way file; demodulate the sampled way file to obtain the encrypted first code block; decrypt the encrypted first code block to obtain the first code block; decode the first code block to obtain the configuration information which includes the AP ID and the password; configure the second electronic device 400 as the AP using the AP ID and the password; after the request for connecting to the AP is received from the first electronic device 300 by the wireless communication device 403, determine whether to connect with the first electronic device 300; and control the wireless communication device 403 to send a notice of permission to the first electronic device 300.

In some embodiments, the processing device 405 may be a CPU, or a MCU, or a DSP etc., or any combination thereof. The memory device 407 may store an operating system and program instructions.

According to one embodiment, a non-transitory computer readable medium, which contains a computer program for connecting to internet through an electronic device, is provided. When the computer program is executed by a processor, it will instruct the processor to: broadcast an acoustic signal which carries configuration information for configuring AP, where the configuration information includes an AP ID, where the configuration information can be extracted from the acoustic signal by the electronic device that receives the acoustic signal and can be used to configure the electronic device as an AP; when an AP having the ID is detected, send to the AP a request for connecting to it to access internet service; and connect to internet through the AP after a notice of permission is received from the AP.

There is little distinction left between hardware and software implementations of aspects of systems; the use of hardware or software is generally a design choice representing cost vs. efficiency tradeoffs. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for connecting a first electronic device to internet through another electronic device, comprising:
broadcasting, with the first electronic device an acoustic signal which carries configuration information for configuring an access point, where the configuration information comprises an access point identifier, where the configuration information is adapted to be extracted from the acoustic signal by another electronic device that receives the acoustic signal and is adapted to be used to configure the electronic device as an access point;
when an access point having the identifier is detected by the first electronic device, sending, with the first electronic device to the access point a request for connecting to the access point to access internet service; and
connecting the first electronic device to internet through the access point after a notice of permission is received from the access point.

2. The method according to claim 1, wherein the configuration information further comprises a password.

3. The method according to claim 1, wherein the configuration information further comprises an identifier of the first electronic device.

4. The method according to claim 1, further comprising:
obtaining, with the first electronic device, the configuration information for configuring access point;
encoding the configuration information; and
modulating the encoded configuration information to form the acoustic signal.

5. The method according to claim 1, wherein the acoustic signal is substantially inaudible.

6. The method according to claim 1, further comprising:
receiving, with a second electronic device, the acoustic signal which carries configuration information for configuring the access point;
extracting, with the second electronic device, the configuration information from the received acoustic signal;
configuring the second electronic device as an access point using the extracted configuration information;
after configuring the second electronic device as an access point, receiving, with the second electronic device, the request for connecting to the access point to access internet service from the first electronic device; and
sending, with the second electronic device, a notice of permission to the first electronic device.

7. The method according to claim 6, wherein the configuration information comprises an access point identifier and a password.

8. The method according to claim 6, wherein the configuration information comprises an access point identifier and an identifier of the first electronic device.

9. The method according to claim 6, wherein the extracting, with the second electronic device, the configuration information from the received acoustic signal comprises:
demodulating, with the second electronic device, the received acoustic signal; and
decoding the demodulated acoustic signal to obtain the configuration information.

10. The method according to claim 6, wherein the acoustic signal is substantially inaudible.

11. A first electronic device, comprising a speaker system, a wireless communication device and a processing device configured to:
control the speaker system to broadcast an acoustic signal which carries configuration information for configuring an access point, where the configuration information comprises an access point identifier, where the configuration information is adapted to be extracted from the acoustic signal by another electronic device that receives the acoustic signal and is adapted to be used to configure the electronic device as an access point;
control the first electronic device to search an access point having the identifier;
after the access point having the identifier is detected, generate a request for connecting to the access point;
control the wireless communication device to send the request to the access point to access internet service; and
control the wireless communication device to connect to internet through the access point after a notice of permission is received from the access point by the wireless communication device.

12. The first electronic device according to claim 11, wherein the configuration information further comprises a password.

13. The first electronic device according to claim 11, wherein the configuration information further comprises an identifier of the first electronic device.

14. The first electronic device according to claim 11, wherein the processing device is further configured to:
obtain the configuration information for configuring access point;
encode the configuration information; and
modulate the encoded configuration information to form the acoustic signal.

15. The first electronic device according to claim 11, wherein the acoustic signal is substantially inaudible.

16. A first electronic device, comprising an acoustic signal receiving device, a wireless communication device and a processing device, configured to:
after an acoustic signal which carries configuration information for configuring an access point is received by the acoustic signal receiving device, extract the configuration information from the received acoustic signal;
configure the first electronic device as an access point based on the configuration information; and
after a request for connecting to the access point is received from a second electronic device by the wireless communication device, control the wireless communication device to send a notice of permission to the second electronic device.

17. The first electronic device according to claim 16, wherein the configuration information comprises an access point identifier and a password.

18. The first electronic device according to claim 16, wherein the configuration information comprises an access point identifier and an identifier of the second electronic device.

19. The first electronic device according to claim 16, wherein the acoustic signal is substantially inaudible.

20. The first electronic device according to claim 16, wherein the processing device is further configured to:
demodulate the received acoustic signal; and
decode the demodulated acoustic signal to obtain the configuration information.
